(19) United States
(12) Patent Application Publication
(10) Pub. No.: US 2020/0210864 A1
(43) Pub. Date: Jul. 2, 2020

(54) METHOD FOR DETECTING COMMUNITY STRUCTURE OF COMPLICATED NETWORK

(71) Applicant: DALIAN MINZU UNIVERSITY, Dalian (CN)

(72) Inventors: Jing XIAO, Dalian (CN); Xueliang BI, Dalian (CN); Hongfei REN, Dalian (CN); Xiaoke XU, Dalian (CN)

(21) Appl. No.: 16/633,770

(22) PCT Filed: May 11, 2018
(86) PCT No.: PCT/CN2018/086541

§ 371 Date: Jan. 24, 2020

(30) Foreign Application Priority Data
Jan. 15, 2018 (CN) 201810036247.7

(51) Int. Cl. G06N 5/04; G06N 3/12

(52) U.S. Cl. CPC G06N 5/04; G06N 3/126

(57) ABSTRACT

The present invention discloses a method for detecting the community structure in complicated networks. In order to improve the global convergence performance of the differential evolution algorithm, three main evolution operations are redesigned, including a classification-based adaptive mutation strategy, a dynamic adaptive parameter adjustment strategy, and a historical information-based selection operation. On the other hand, in order to make better use of the network topology information, the present invention provides a neighborhood information-based improved community adjustment strategy to ensure that sufficient search space is provided for the global optimal community division, while reducing the search space of DE. Finally, the present invention provides a new modularity optimization algorithm CDEMO based on differential evolution algorithm.

### TECHNICAL FIELD

The present invention relates to the method for detecting community, particularly, to the method for detecting the community structure of a complicated network.

### BACKGROUND

A large variety of methods for detecting community have been provided in the last few years. Among which, the most widely used methods are modularity-based optimization methods. However, modularity optimization is essentially a typical NP-hard problem. Traditional deterministic optimization algorithms, such as mathematic programming methods, greedy algorithms, spectral analysis methods, and extreme value optimization algorithms usually occurs premature convergence or convergence stagnation. In addition, with the increase of a real world network scale and the structural ambiguity, the extreme value degradation problem in the optimization process becomes more serious. This means it becomes more difficult to find a global optimization community division among many local optimal solutions that grows exponentially. Therefore, the accuracy and the stability of the community structure obtained by detection are seriously affected.

In recent years, nature-inspired metaheuistic algorithms, especially Evolutionary Algorithms (EAs) have been successfully applied to modularity optimization problems, such as a Genetic Algorithm (GA), Particle Swarm Optimization (PSO), Memetic Algorithm (MA), Ant Colony Optimization (ACO), Clonal Selection (CS), and Differential Evolution (DE). It is noteworthy that the EA-based modularity optimization methods have significant advantages in a variety of detection problems due to its strong global optimization capability. In addition, considering that it is relatively difficult to obtain prior information in the real world networks, this type of algorithm does not require any prior information (such as the number of communities) and particular mathematical models. However, although satisfactory results have been achieved for the EA-based modularity optimization methods in a variety of the community structure of the complicated network detection problems, the problem of the premature convergence and extreme value degradation have not been fully solved.

In order to solve the problems and improve the optimal community division quality, the convergence performance of the EA-based modularity optimization algorithms should be further improved. The preliminary experimental result shows that the convergence performance of the EA-based modularity optimization algorithms mainly depends on two key factors. The first and the most important factor is how to improve the global convergence ability of an EA itself, another factor is how to efficiently use the network topology information to reduce the huge search space in the modularity optimization process. However, as far as we know, in the existing algorithms, basic EAs are usually directly used as optimization strategies and their convergence ability is ignored, which leads to the premature convergence of EAs, and the quality of optimal community division obtained is not at its best. At the same time, although some existing algorithms have improved the evolution operations in the EAs to meet the requirements of community detection by fusing the network topology information, the inappropriate use of the topology information destroys the search space of the global optimal community division.

### SUMMARY

Considering the disadvantages of the prior art, the present invention provides a method for detecting the community structure of the complicated network. On one hand, in order to improve the global convergence performance of a differential evolution algorithm, three main evolution operations are re-designed, including a classification-based adaptive mutation strategy, a dynamic adaptive parameter adjustment strategy, and a historical information-based selection operation. On the other hand, in order to make better use of the network topology information, an improved community adjustment strategy based on neighborhood information is provided to ensure that sufficient search space is provided for the global optimal community division, while reducing the DE search space. Finally, a new DE-based modularity optimization algorithm CDEMO is provided.

In order to achieve the purposes above, the present invention provides a method for detecting the community structure of the complicated network, specifically including:

the step of improving the global convergence performance of the differential evolution algorithm; the step of performing community correction based on improved neighborhood information; and a classification differential evolution algorithm-based modularity optimization method.

Furthermore, the step of improving the global convergence performance of the DE algorithm specifically includes:

(1) a classification adaptive differential mutation strategy;

(2) dynamic adaptive parameter adjustment;

(3) performing a differential selection operation based on historical information.

Furthermore, the specific operations of the classification adaptive differential mutation strategy are as follows:

for each target individual X_{i,t}, if its individual fitness value fᵢ is greater than the average of individual fitness values of the whole population, X_{i,t} is classified as a superior individual, and its position in the search space is closer to a global optimal solution; therefore, the good genes in X_{i,t} are reserved to enhance the local search around the individual, and the corresponding mutation vector V_{i,t} is generated as follows:

V_{i,t}=F_{i,t}·X_{pbesti,t}+W_{i,t}·(X_{r2,t}−X_{r3,t}) (1)

where X_{pbesti,t} indicates the historical optimal solution of the individual X_{i,t} in the previous t generations and is used for improving the individual exploration capability; X_{r2,t} and X_{r3,t} are two different individuals randomly selected from the population and satisfy the condition: r2≠r3≠i; F_{i,t} and W_{i,t} are control parameters of Xᵢ, and their values are dynamically adjusted according to an evolutional algebra and the individual fitness value of X_{i,t}.

for each target individual X_{i,t}, if its individual fitness value fᵢ is less than the average of the individual fitness values of the whole population, X_{i,t}, is classified as a poor individual, and its position in the search space is far from the global optimal solution; therefore, the communication between the poor individual and the superior individual should be enhanced to promote the global search, the corresponding mutation vector V_{i,t} is generated as follows:

V_{i,t}=W_{i,t}·X_{r1,t}·K_{i,t}·(X_{gbest,t}−X_{i,t}) (2)

where X_{r1,t} is an individual randomly selected from the population and satisfies the condition: r1≠i; X_{gbest,t} indicates the optimal solution in the current iterative population, and is used for improving the exploration capability of X_{i,t}; W_{i,t} and K_{i,t} are control parameters of Xᵢ, and their values are dynamically adjusted according to an evolutional algebra and the individual fitness value of X_{i,t}.

Furthermore, for the dynamic adaptive parameter adjustment, three control parameters W, K, and F is respectively a random component, a social component, and a cognitive component in the mutation process. In addition, a key control parameter CR is also included in a crossover operation for determining the percentage of each test individual u_{i,t} inherited from a mutant individual V_{i,t}; the adjustment process is specifically as follows:

1. Adaptive parameter adjustment according to the fitness value of the individual: for a poor individual, the degree of mutation and crossover is enhanced so as to introduce more orientation information into the evolution process. Therefore, the random component and the social component in the mutation process, and the inheritance in the crossover process are all enhanced, corresponding to the values of W and K in formula (2), and CR in the crossover operation are larger. In contrast, for a superior individual, to enhance the cognitive component in the mutation process, and parameter adjustment should comply with the contrast principle, corresponding to the larger F value, and the smaller W value in formula (1).

2. Dynamic adaptive adjustment according to the number of evolutionary iterations: in the early stage of evolution, the exploration capability of an individual is improved to ensure the sufficient search in the neighborhood of each individual. In contrast, in the later stage of evolution, the exploitation capability of an individual is improved, the communication between individuals is improved, and the convergence of the whole population is accelerated. According to this principle, values of F, W, and CR gradually decrease, while the value of K gradually increases in the evolution process.

According to the above principle, parameter values can be adaptively adjusted, and each individual can be dynamically controlled during the evolution process. The specific operation process is as follows:

$$\begin{matrix}{W}_{i , t} = {W}_{min} + ( {W}_{max} - {W}_{min} ) \times ( ( 2 - exp ( \frac{t}{{t}_{max}} \times ln 2 ) ) \times \frac{1}{2} + \frac{{f}_{max , t} - {f}_{i , t}}{{f}_{max , t} - {f}_{min , t}} \times \frac{1}{2} ) & ( 3 ) \\ {K}_{i , t} = {K}_{min} + ( {K}_{max} - {K}_{min} ) \times ( ( exp ( \frac{t}{{t}_{max}} \times ln 2 ) - 1 ) \times \frac{1}{2} + \frac{{f}_{max , t} - {f}_{i , t}}{{f}_{max , t} - {f}_{min , t}} \times \frac{1}{2} ) & ( 4 ) \\ {F}_{i , t} = {F}_{min} + ( {F}_{max} - {F}_{min} ) \times ( ( 2 - exp ( \frac{t}{{t}_{max}} \times ln 2 ) ) \times \frac{1}{2} + \frac{{f}_{i , t} - {f}_{min , i}}{{f}_{max , t} - {f}_{min , t}} \times \frac{1}{2} ) & ( 5 ) \\ {CR}_{i , t} = {CR}_{min} + ( {CR}_{max} - {CR}_{min} ) \times ( ( 2 - exp ( \frac{t}{{t}_{max}} \times ln 2 ) ) \times \frac{1}{2} + \frac{{f}_{max , t} - {f}_{i , t}}{{f}_{max , t} - {f}_{min , t}} \times \frac{1}{2} ) & ( 6 )\end{matrix}$$

Furthermore, the differential selection operation based on the historical information is specifically as follows:

All excellent solutions generated during the whole evolution process are saved in the historical information for subsequent evolution operations. In order to achieve this objective, a special population pbest_pop is introduced. A historical optimal solution X_{pbesti,t} of each individual in the population constitutes a population pbest_pop, which is generated at the initialization stage, and updated after each evolution operation. For each individual X_{i,t} in the population, if its fitness value is improved during a certain evolution operation process, a newly generated individual is used as the current historical optimal solution of X_{i,t}, and saved to pbest_pop. After each generation of evolution operations, all individuals in pbest_pop will replace all individuals in a population pop, and the current optimal solution X_{gbest,t} is selected from pbest_pop.

Furthermore, the specific steps of performing community correction based on improved neighborhood information are: if a node satisfies a community correction condition, the node may be replaced into the community to which all neighborhood nodes belong, and the probability of replacement is proportional to the scale of the neighborhood community.

Furthermore, the modularity optimization algorithm based on the classification differential evolution algorithm is specifically:

S1: initializing a population;

S1.1 setting network parameters, including the number of nodes n, an adjacent matrix adj, and a community correction threshold δ; and setting parameters of a DE algorithm, including an individual dimension D, a population size NP, the number of population iterations t, and the maximum iteration tₘₐₓ;

S1.2 randomly initializing the population pop with the community-labeled individual representation approach;

S2: recognizing and recording an optimal solution;

S2.1 recognizing and recording the optimal individual X_{gbest,t} in the population pop of t-th generation;

S2.2 recognizing and recording a historically optimal solution X_{pbesti,t} of each individual X_{i,t} in the population pop of the t-th generation; and establishing an initial population pbest_pop from X_{pbesti,t} of all population individuals;

S3: when the number of population iterations is less than the maximum population iteration, automatically adding one to the number of population iterations; and the cycle of S3.1-S3.5 is terminated if the conditions are not satisfied;

S3.1 establishing a mutation population mutation_pop by an adaptive classification differential mutation strategy;

when the value of i is within the range from 1 to the value of the population size, carrying out cycle of steps a) to e); if the value of i is not within the range from 1 to the value of the population size, skipping steps a) to e) and terminating the cycle;

a) randomly selecting 3 different individuals X_{r1,t}, X_{r2,t}, and X_{r3,t} from the population pop;

b) dynamically adjusting mutation parameters F_{i,t}, w_{i,t}, and K_{i,t};

c) classifying X_{i,t} according to the fitness value Q;

d) generating a mutation individual V_{i,t}, according to the adaptive classification differential mutation strategy;

e) calculating the modularity value of V_{i,t}, and comparing it with the individual X_{i,t} and saving the better individual into pbest_pop;

if i is greater than NP, skipping the steps a) to e);

S3.2 performing community correction based on neighborhood information;

S3.3 constructing a crossover population crossover_pop, according to the mutation population mutation_pop and the population pop;

when the value of i is in the ranges from 1 to the value of the population size, carrying out steps a) to d); if the value of i does is not in the range from 1 to the value of the population size, skipping the steps a) to d), and terminating the cycle;

a) initializing an i-th individual u_{i,t}=x_{i,t} in the crossover population;

b) dynamically adjusting a crossover parameter CR_{i,t};

c) adjusting a test individual u_{i,t} by inheriting community information from the mutation individual V_{i,t};

d) calculating the modularity value of u_{i,t}, and comparing it with an i-th individual in pbest_pop, and saving the better value into pbest_pop;

S3.4 performing community correction based on neighborhood information;

S3.5 updating the pop by replacing all individuals in pbest_pop;

S4: outputting X_{gbest,t} in the pop as the final optimal community division; otherwise, returning to step S3.

The technical solution of the present invention can achieve the following technical effects:

Classification-based adaptive mutation will affect all individuals in each generation of the population until the evolution ends. Therefore, the mutation of each individual can be purposefully adjusted. On the one hand, the exploration capability of a superior individual can be enhanced to increase the possibility of finding the global optimum in its neighborhood. On the other hand, the exploitation capability of a poor individual can be enhanced to accelerate their search speed for global optimization. In short, the evolution requirements of individuals with different fitness properties can be better satisfied by a new mutation strategy. Guided by the orientation information, the blindness in the search process can be efficiently reduced, and the quality of offspring individuals and the optimal solution can also be improved. Moreover, the mutation degree of each individual can be dynamically and adaptively adjusted during the evolution process. All excellent solutions generated during the whole evolution process will be also saved as the historical information for subsequent evolution operations.

The new collection strategy can efficiently reduce the search space, and can relax the limitations on the community correction, provide the sufficient search space for the global optimal solution, thereby better utilizing the known topology information of the network and promoting the convergence of the CDEMO algorithm.

The CDEMO algorithm can efficiently recognize community structures of complicated networks, and improve the accuracy, the stability, and the extensibility of the optimal community division, including those complicated networks with extremely ambiguous community structures.

### BRIEF DESCRIPTION OF THE DRAWINGS

FIG. 1 is a flowchart of adaptive differential evolution algorithm based on classification;

FIG. 2 is a CDEMO flowchart of the modularity optimization algorithm based on differential evolution;

FIG. 3 is an average NMI value diagram of CDEMO and other algorithms obtained by the different zout values of GN networks;

FIG. 4 is an average NMI value diagram of CDEMO and other algorithms obtained by the different μ values of LFR networks;

FIG. 5 is the community structure division recognition diagram of the CDEMO algorithm on the Karate network;

FIG. 6 is the community structure division recognition diagram of the CDEMO algorithm on the Dolphin network;

FIG. 7 is the community structure division recognition diagram of the CDEMO algorithm on the Polbooks network;

FIG. 8 is the community structure division recognition diagram of the CDEMO algorithm on the Football network.

### DETAILED DESCRIPTIONS

To make the purpose, the technical solutions and the advantages of the present invention more clearly, the present invention is described in details below with reference to the accompanying drawings and detailed embodiments.

### Example 1

The present example provides a method for detecting the community structure of the complicated network, specifically including:

I. In order to improve the global convergence performance of a DE algorithm, three main evolution operations are redesigned:

(I) A Classification Adaptive Differential Mutation Strategy

The improvement measures mainly include the following:

1. The current population optimal solution X_{gbest,t} and a historical optimal solution X_{pbesti,t} of each individual are used for substituting the randomly selected individual to guide mutation direction;

2. A new adaptive classification mechanism is proposed and utilized for balancing exploration and exploitation capabilities of individuals with different fitness properties;

3. The mutation degree of each individual in the evolution process is dynamically and adaptively adjusted through parameters.

The specific operations of the new mutation strategy are described as follows:

for each target individual X_{i,t}, if its individual fitness value fᵢ is greater than the average of the individual fitness values of the whole population, X_{i,t} is classified as a superior individual, and its position in the search space is closer to the global optimal solution. Therefore, the good genes in X_{i,t} should be reserved to enhance the local search around the individual. The corresponding mutation vector V_{i,t} is generated as follows:

V_{i,t}=F_{i,t}·X_{pbesti,t}+W_{i,t}·(X_{r2,t}−X_{r3,t}) (1)

X_{pbesti,t} indicates a historical optimal solution of the individual X_{i,t} in the previous t generations and is used for enhancing the individual exploration capability; X_{r2,t} and X_{r3,t} are two different individuals randomly selected from the population; and satisfy the condition: r2≠r3≠i; F_{i,t} and W_{i,t} are control parameters of Xᵢ, and their values are dynamically adjusted according to an evolutional algebra and the individual fitness value of X_{i,t}.

for each target individual X_{i,t}, if its individual fitness value fᵢ is less than the average of the individual fitness values of the whole population, X_{i,t} is classified as a poor individual, and its position in the search space is far from the global optimal solution. Therefore, the communication between the poor individual and the superior individual of the population should be enhanced to promote the global search. The corresponding mutation vector V_{i,t} is generated as follows:

V_{i,t}=W_{i,t}·X_{r1,t}+K_{i,t}·(X_{gbest,t}−X_{i,t}) (2)

wherein X_{r1,t} is an individual randomly selected from the population; and satisfies the condition: r1#i; X_{gbest,t} indicates the optimal solution in the current iterative population, and is used for improving the exploration capability of X_{i,t}; W_{i,t} and K_{i,t} are control parameters of Xᵢ, and their values are dynamically adjusted according to an evolutional algebra and the individual fitness value of X_{i,t}.

The beneficial effects are: the above classification-based adaptive mutation will affect all individuals in each generation of the population until the evolution ends. Therefore, the mutation of each individual can be purposefully adjusted. On the one hand, the exploration capability of a superior individual can be enhanced to increase the possibility of finding the global optimum in its neighborhood. On the other hand, the production capability of a poor individual can be enhanced to accelerate their search speed for global optimization. In short, the evolution requirements of individuals with different fitness properties can be better satisfied by a new mutation strategy. Guided by the orientation information, the blindness in the search process can be efficiently reduced, and the quality of offspring individuals and the optimal solution can also be improved.

(II) Dynamic Adaptive Parameter Adjustment

Three control parameters W, K, and F respectively corresponds to the random component, the social component, and the cognitive component of the mutation process. In addition, a key control parameter CR is also included in a crossover operation for determining the percentage of each test individual u_{i,t} inherited from the mutant individual V_{i,t}.

1. Adaptive parameter adjustment based on individual fitness values: for the poor individual, the degree of the mutation and crossover should be improved, so as to introduce more orientation information during the mutation process. Therefore, the random component and the social component in the mutation process, and the inheritance in the crossover process should all be enhanced. Accordingly, values of W and K in formula (2), and the of CR in the crossover are larger. In contrast, for the superior individual, the cognitive part in the mutation process should be enhanced, and the parameter adjustment should comply with the contrast principle, corresponding to the larger F value, and the smaller W value in formula (1).

2. Dynamic adaptive adjustment based on the number of evolutionary iterations: in the early stage of evolution, the exploration capability of an individual should be enhanced to ensure the sufficient search within each individual neighborhood. In contrast, in the later stage of evolution, the production capability of an individual should be enhanced, the communication between individuals should be enhanced, and the convergence of the whole population should be accelerated. According to this principle, values of F, W, and CR gradually decrease, and the value of K gradually increases during the evolution process.

Based on the above principles, parameters values can be adaptively adjusted, and each individual can be dynamically controlled during the evolution process. The specific operation process is as follows:

$$\begin{matrix}{W}_{i , t} = {W}_{min} + ( {W}_{max} - {W}_{min} ) \times ( ( 2 - exp ( \frac{t}{{t}_{max}} \times ln 2 ) ) \times \frac{1}{2} + \frac{{f}_{max , t} - {f}_{i , t}}{{f}_{max , t} - {f}_{min , t}} \times \frac{1}{2} ) & ( 3 ) \\ {K}_{i , t} = {K}_{min} + ( {K}_{max} - {K}_{min} ) \times ( ( exp ( \frac{t}{{t}_{max}} \times ln 2 ) - 1 ) \times \frac{1}{2} + \frac{{f}_{max , t} - {f}_{i , t}}{{f}_{max , t} - {f}_{min , t}} \times \frac{1}{2} ) & ( 4 ) \\ {F}_{i , t} = {F}_{min} + ( {F}_{max} - {F}_{min} ) \times ( ( 2 - exp ( \frac{t}{{t}_{max}} \times ln 2 ) ) \times \frac{1}{2} + \frac{{f}_{i , t} - {f}_{min , i}}{{f}_{max , t} - {f}_{min , t}} \times \frac{1}{2} ) & ( 5 ) \\ {CR}_{i , t} = {CR}_{min} + ( {CR}_{max} - {CR}_{min} ) \times ( ( 2 - exp ( \frac{t}{{t}_{max}} \times ln 2 ) ) \times \frac{1}{2} + \frac{{f}_{max , t} - {f}_{i , t}}{{f}_{max , t} - {f}_{min , t}} \times \frac{1}{2} ) & ( 6 )\end{matrix}$$

The beneficial effect is that the degree of mutation of each individual is adaptively adjusted during the evolution process.

(III) Differential Selection Operation Based on Historical Information

All excellent solutions generated in the whole evolution process will be saved as the historical information for subsequent evolution operations. In order to achieve this objective, a special population pbest_pop is introduced. A historical optimal solution X_{pbesti,t} of each individual in the population constitutes the population pbest_pop, which is generated during the initialization stage, and updated after each evolution operation. For each individual X_{i,t} in the population, if its fitness value is improved during a certain evolution operation process, a newly generated individual will be used as the current historical optimal solution of X_{i,t}, and saved to pbest_pop. After each generation of evolution operations, all individuals in pbest_pop will replace all individuals in the population pop, and the current optimal solution X_{gbest,t} will be selected from pbest_pop.

The beneficial effect is that all excellent solutions generated during the whole evolution process will be saved as the historical information for subsequent evolution operations.

Convergence tests of an improved differential evolution algorithm:

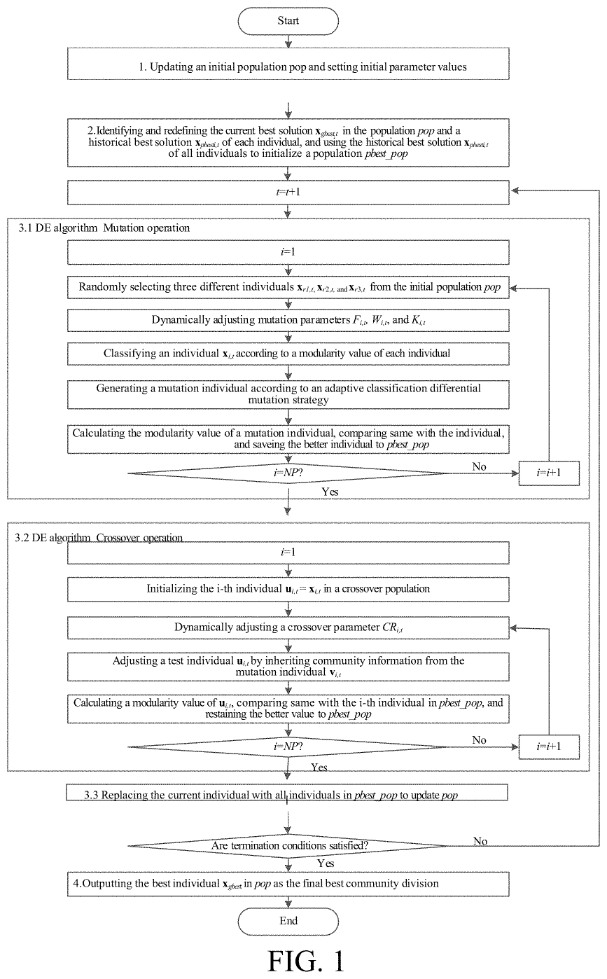

The above three improvement measures are all to improve the global convergence of the DE algorithm. The improved algorithm flowchart is shown in FIG. 1.

Unlike the standard DE algorithm, more orientation information is incorporated in a new mutation operation. Therefore, individuals can mutate more specifically. In addition, the selection operation is not performed after the crossover operation, but is selected by updating the population pbest_pop after each evolution operation, and retain the excellent solution.

In order to verify the above improvement measures of DE, 18 standard Benchmark functions are used for testing the improved algorithms, where f1-f5 are unimodal functions, f6-f14 are basic multimodal functions, f15 and f16 are extension functions, and f17 and f18 are combination functions. Table 1 provides details of the standard Benchmark functions.

Performance comparison is made between with the improved DE algorithm and four efficient and widely used DE algorithm modes, including DE/rand/2/dir, DE/rand/1/bin, DE/current-to-best/2/bin, and DE/best/1/bin. For ease of comparison, the algorithm using the new mutation strategy and the parameter adaptive adjustment strategy is named as DE_version1, and the DE algorithm using all three improvement measures is named as DE_version2.

During the experiment process, the same initial population size NP=100, the same variable dimension D=30, and the same termination criterion Max_FEs=5.0e+0.5 are used for all algorithms on each test issue. In addition, parameters F and CR in the DE algorithm of all modes are adjusted according to the adaptive manner shown in formulas (5) and (6). The range of related parameters is W∈[0.1,0.9], K∈[0.3,0.9], F∈[0.3,0.9], and CR∈[0.1,0.9].

Six modes of DE algorithms are compared in the accuracy and robustness of the optimal solution. The experimental results are shown in Table 2, including the average value and the standard deviation of optimal solutions (in bracket) calculated by independently operating each test function for 30 times. The optimal solution of each test function is shown in bold. We can see from Table 2 that DE_version1 and DE_version2 are better than other four algorithms in almost all test functions. DE_version2 is successfully converged to the true global optimal solution in 50.0% of the test functions, and performs optimally in 88.9% of the test functions. The above results prove that a classification-based adaptive mutation strategy can efficiently improve the quality of offspring individuals and the accuracy of the optimal solution. In addition, compared with DE_version1, the accuracy of DE_version2 is significantly improved, which indicates that the new selection operation based on historical information can efficiently improve the global convergence capability of the DE algorithm.

The above experimental results show that the improvement method provided in the application is successful and effective, can efficiently improve the global convergence performance of an original standard DE algorithm, and provides an efficient global optimization method for the modularity optimization problem of the detection of the community structure of a complicated network.

II. In order to make better use of the network topology information, an improved community adjustment strategy based on neighborhood information is provided to ensure that sufficient search space is provided for the global optimal community division while reducing the DE search space.

Regarding the improved DE algorithm, in order to make a better use of the network topology information, an improved community correction strategy based on neighborhood information is provided:

In order to avoid the inappropriate use of the topology information, a new community correction strategy is provided in CDEMO. If a node satisfies a community correction condition, the node may be replaced into the community to which all its neighborhood nodes belong, and the probability of placement is proportional to the scale of the neighborhood community.

The beneficial effects are: like the original strategy, the new correction strategy can efficiently reduce the search space, more importantly, it can relax the limitations on the community correction, provide the sufficient search space for the global optimal solution, thereby making a better use of the known topology information of a network and promoting the convergence of the CDEMO algorithm.

III. New DE-Based Modularity Optimization Algorithm CDEMO

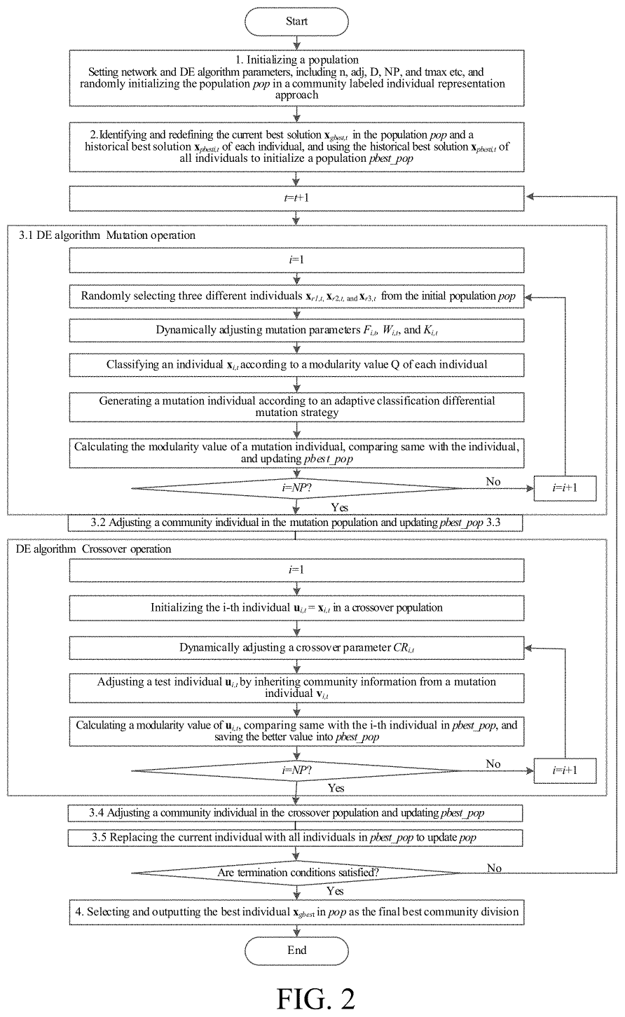

(I) CDEMO algorithm, the algorithm flowchart is shown in FIG. 2:

1: initializing a population;

1.1 setting network parameters, including the number of nodes n, an adjacent matrix adj, and a community correction threshold δ; and setting parameters of a DE algorithm, including an individual dimension D, a population size NP, the number of population iterations t, and the maximum iteration tₘₐₓ;

1.2 randomly initializing the population pop by the community labeled individual representation approach;

2: recognizing and recording an optimal solution;

2.1 recognizing and recording the optimal individual X_{gbest,t} in the population pop of the t-th generation;

2.2 recognizing and recording a historical optimal solution X_{i,t} of each individual X_{pbesti,t} in the population pop of the t-th generation; and establishing an initial population pbest_pop from X_{pbesti,t} of all population individuals;

3: when the number of population iterations is less than the maximum population iteration, automatically adding one to the number of population iterations; and the cycle of S3.1-S3.5 is terminated if the conditions are not satisfied;

3.1 establishing a mutation population mutation pop by an adaptive classification differential mutation strategy;

when the value of i is in the range from 1 to the value of the population size, carrying out cycle of steps a) to e); if the value of i is not in the range from 1 to the value of the population size, skipping the steps a) to e) and terminating the cycle.

a) randomly selecting three different individuals X_{r1,t}, X_{r2,t}, and X_{r3,t} from the population pop;

b) dynamical adjusting mutation parameters F_{i,t}, w_{i,t}, and K_{i,t};

c) classifying X^{i,t} according to a fitness value Q;

d) generating mutant individuals V_{i,t} according to the adaptive classification differential mutation strategy;

e) calculating the modularity value of V_{i,t} and comparing with the individual X_{i,t} and saving the better individual to pbest_pop;

if i is greater than NP, skipping the steps a) to e);

3.2 performing community correction based on neighborhood information;

3.3 constructing a crossover population crossover_pop according to the mutation population mutation_pop and the population pop;

when the value of i is in the range from 1 to the value of the population size, carrying out the cycle of steps a) to d); when the value of i is not in the range from 1 to the value of the population size, skipping the steps a) to d) and terminating the cycle.

a) initializing the i-th individual u_{i,t}=x_{i,t} in the crossover population;

b) dynamically adjusting a crossover parameter CR_{i,t};

c) adjusting a test individual V^{i,t} by inheriting community information from the mutation individual u_{i,t};

d) calculating the modularity value of u_{i,t}, and comparing it with an i-th individual in pbest_pop, and saving the better value to pbest_pop;

3.4 performing community correction based on neighborhood information;

3.5 updating the pop by replacing all individuals in the pbest_pop.

4: if the stopping criterion is satisfied, stopping the algorithm and outputting X_{gbest,t} in the pop as the final optimal community division; otherwise returning to step 3.

The beneficial effects are: the CDEMO algorithm can efficiently recognize community structures of complicated networks and improve the accuracy, the stability, and the extensibility of the optimal community division, including those complicated networks with extremely ambiguous community structures.

CDEMO Algorithm Performance Test:

The effectiveness of a new community correction strategy, and whether the improvement of the convergence capability of the DE algorithm is beneficial for its application in the modularity optimization will be verified by the experiments. Six DE-based modularity optimization algorithms are constructed, named as DEMO1-6. These algorithms use different DE algorithms (with different test individual generation strategies) as optimization strategies for optimizing modularity. In DEMO1-4, different DE algorithms are applied, including DE/rand/2/dir, DE/rand/1/bin, DE/current-to-best/2/bin, and DE/best/1/bin. DEMO5 uses a widely used random mutation strategy, i.e., the node community ownership is adjusted in a completely random manner. DEMO6 uses the improved DE version2 as an optimization strategy. On the basis of DEMO6, a new community correction operation combined with the previously provided improvements to improve the global convergence of the algorithm, reducing the search space of the algorithm and ensuring the global optimal solution search space, we construct CDEMO.

All algorithms are tested on four real world social networks, as shown in Table 3, including Karate club network, Dolphins network, PolBooks network, and Football network. The experimental results are shown in Table 4, including the average value and the standard deviation of the modularity value Q obtained by independently operating each algorithm for 30 times on each test network.

We can clearly see from Table 4 that there is a large difference among the performance of the DE algorithm in different modes on the modularity optimization, due to different convergences. Compared with DEMO3 and DEMO4, random components in mutation strategies of DEMO1-2 and DEMO5 make them have stronger exploration capabilities, and thus, better values Qavg and Qstd can be obtained. In addition, the terms of accuracy and stability of the optimal community division, DEMO6 performs better than DEMO1-5, proving that the improved convergence capability of the DE algorithm is beneficial for its application in the modularity optimization. Compared with DEMO6, CDEMO gets better Qavg and Qstd values on Karate network, Dolphin network, and PolBooks network, and the accuracy of the detected community is further improved.

Based on the above test results, we can conclude that enhancing the convergence performance of the algorithm from improving the global convergence capability of the DE algorithm and improving the efficiency of using topology information, does indeed help to improve the quality of the optimal community division in modularity optimization problems.

IV. Community Detection Performance Test

1. Experiment Settings

The performance of the CDEMO algorithm is evaluated on a synthesized network and real world social networks. The CDEMO algorithm is implemented in MATLAB 7.0 software programming, and is tested on Windows 7 system using a Pentium dual-core 2.5 GHz processor and 2.0 GB memory. Parameters in CDEMO are set as follows: the value of the population size NP is 100; the maximum number of iteration tmax is 200; the value range of control parameters is set to: W∈[0.1,0.9], K∈[0.3,0.9], F∈[0.3,0.9], and CR∈[0.1,0.9].

2. Performance Evaluation Standards

(1) Modularity Q: for a real world network with unknown community structure, a modularity function is ususally used as a performance indicator for calculating the significance level of the community structure obtained by detection. The modularity is defined as:

$$Q = \frac{1}{2 M} {\sum }_{ij} ( {a}_{ij} - \frac{{k}_{i} {k}_{j}}{2 M} ) δ ( i , j ) \qquad ( 7 )$$

Wherein M is the total number of network edges; A=(aij)n*n is a network adjacent matrix; ki and kj represent the degree of nodes i and j, respectively; δ(i,j) represents the community ownership relationship between node i and node j; if i and j belong to the same community, the value of δ(i,j) is 1; otherwise, the value of δ(i,j) is 0. When the value of Q is greater than 0, it indicates that there is a community structure in a network; when the value of Q is greater than 0.3, it indicates that the community structure of the network is significant. The larger the value of Q, the community structure is the more significant. Although the modularity has a resolution limitation, it is still the most widely used standard of evaluating the community division quality at present.

(2) Normalized Mutual Information (NMI): for a synthesized network with a known community structure, NMI is usually used as a performance indicator for calculating the degree of closeness between the detected community division and the real community division. The calculation formula is as shown in (8). Assuming that A is the real community division of a network, and B is the detected community division. A hybrid matrix C is defined as: the row indicates the community division in A, and the column indicates the detected community division in B. An element Cij indicates the i-th community in division A has the same number of nodes as the j-th community in division B. According to the definition of C, the evaluation standard NMI is defined as:

$$NMI ( A , B ) = \frac{- 2 {\sum }_{i = 1}^{{C}_{A}} {\sum }_{j = 1}^{{C}_{B}} {C}_{ij} log ( \frac{{C}_{ij} N}{{C}_{i} {C}_{j}} )}{{\sum }_{i = 1}^{{C}_{A}} {C}_{i} log ( \frac{{C}_{i}}{N} ) + {\sum }_{j = 1}^{{C}_{B}} {C}_{j} log ( \frac{{C}_{j}}{N} )} \qquad ( 8 )$$

wherein, N indicates the node number in the network; CA and CB respectively indicate the number of communities in divisions A and B; Ci is the sum of elements in the i-th row of the hybrid matrix C, which represents the node number of the i-th community in the division A; Cj is the sum of elements in the j-th column in the hybrid matrix C, which represents the node number of the j-th community in the division B. If A and B are identical, NMI takes the maximum value of 1; conversely, if A and B are completely different, NMI takes the value of 0.

3. Experimental Result of Synthesized Network

The community detection performance of the CDEMO algorithm is verified on extended GN Benchmark networks provided by Lancichinetti, etc. Each GN network includes 128 nodes that are divided into 4 communities, and each community includes 32 nodes. The number of connecting edges between each node and other nodes in the community is Zin, and the number of connecting edges between each node and other node out of the community is Zout. The sum of Zin and Zout is equal to 16 of the node degree. The larger the value of Zout is, the more the connecting edges between nodes and external nodes in the community, the less significant the community structure of the network, and the higher the detection performance requirements of the detection algorithm.

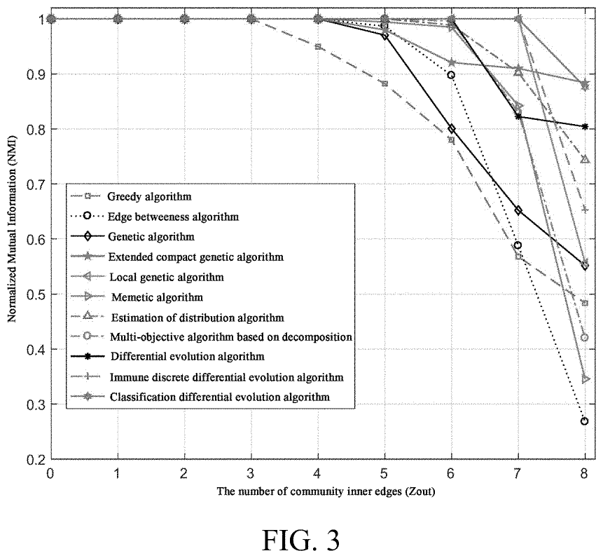

The CDEMO algorithm is tested on nine different GN networks with Zout values increased gradually. The accuracy and the stability of the algorithm are evaluated according to the average value of the NMI obtained by independently operating the algorithms for 30 times on each network, and compared with ten typical modularity optimization algorithms (including CNM, GN, GATHB, ECGA, LGA, MA, UMDA, MOEA/D-Net, DECD, and IDDE). The experimental results are shown in FIG. 3.

It can be seen from FIG. 3 that all algorithms can obtain optimal NMI value, when Zout≤3, i.e., the community structure of the GN network is successfully detected. However, with the value of Zout increasing gradually, the community structure of the network becomes more ambiguous and difficult to recognize, and the NMI values obtained by all algorithms gradually decrease. It should be noted that the detection results of the CDEMO algorithm are always better than that of other 10 algorithms, especially after Zout>3, which indicates that the CDEMO algorithm is more accurate and stable in the community detection of the computer synthesized networks.

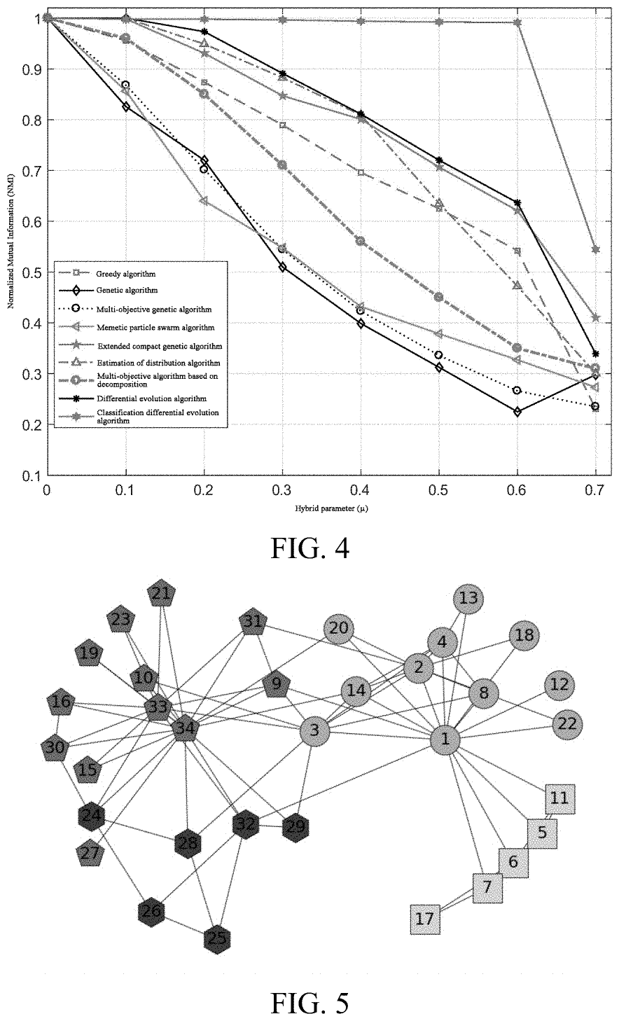

In order to further test the extensibility of the CDEMO algorithm, a test experiment is performed on a larger-scale LFR Benchmark network with a gradually increased hybrid parameter μ. The node degree distribution of the LFR network is a power law distribution, and the community size is variable. Therefore, it is more close to the real world network characteristics. The network hybrid parameter μ determines the number of shared edges between nodes in the community and nodes in other communities. The larger the value, the more ambiguous the network community structure is. In the test, 8 LFR networks with an interval of 0.1 of μ value increased from 0 to 0.7 are used. Each LFR network includes 1,000 nodes; the range of the community size is [10,50]; the average degree of each node is 20; the maximum degree is 50. The CDEMO algorithm independently operates for 30 times on each LFR network, and compared with 8 algorithms CNM, GATHB, MOGA-Net, MPSOA, ECGA, UMDA, MOEA/D-Net, and DECD. The NMI is used for measuring the accuracy and the stability of the detected community structure. The experimental results are shown in FIG. 4.

We can note from FIG. 4 that, compared with other modularity optimization algorithms, CDEMO algorithm can obtain the optimal NMI value on 8 LFR networks. When μ<0.2, the performance advantage of the CDEMO algorithm is not significant; however, with the value of μ increasing, the advantages of the accuracy and the stability of the CDEMO algorithm gradually become significant. The above experimental results show that the CDEMO has better accuracy, stability, and extensibility in the community detection of a synthesized network.

4. Experimental Results on Real World Networks

The performance of the CDEMO algorithm is verified on the real world social networks shown in Table 3, and 16 module recognition algorithms are used to compare the performance with CDEMO. The comparison algorithms are divided into three groups: the first group includes 6 traditional deterministic modularity optimization algorithms, including Fast Nm, CNM, GN, BGLL, MSFCM, and FMM/H1; the second group includes 4 GA-based modularity optimization algorithms, including GATHB, MOGA-Net, ECGA, and MOEA/D-Net; the last group includes 5 PSO and DE-based modularity optimization algorithms, including Meme-Net, MODPSO, DECD, CCDECD, and IDDE. All algorithms independently operate for 30 times on each test network, and the modularity Q is used for measuring the optimal community division quality. Tables 5-7 record the optimal values of Q obtained by CDEMO and other comparison algorithms.

The experimental results in Tables 5-7 show that although all algorithms can recognize the community structure in a real network, and there is no great difference between performances of algorithms in the first category, the EA-based modularity optimization algorithms have significant advantages, compared with the traditional deterministic modularity optimization algorithms. In the EA-based algorithms, the Q values obtained by DECD, CCDECD, IDDE, and CDEMO are relatively high, which proves the advantage of the DE-based optimization strategy. Although the PSO-based modularity optimization algorithms (Meme-Net and MODPSO) can detect the optimal community in the network Karate, their performances on other networks are not good. Compared with DECD, CCDECD, and IDDE, only CDEMO algorithm can always get the optimal Q value, especially on Dolphin and Polbooks networks.

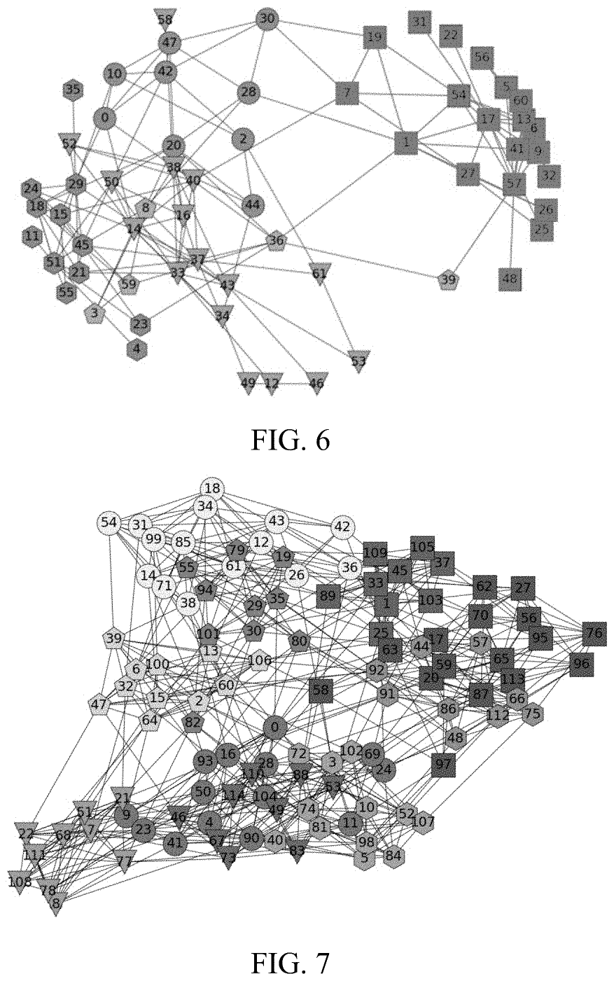

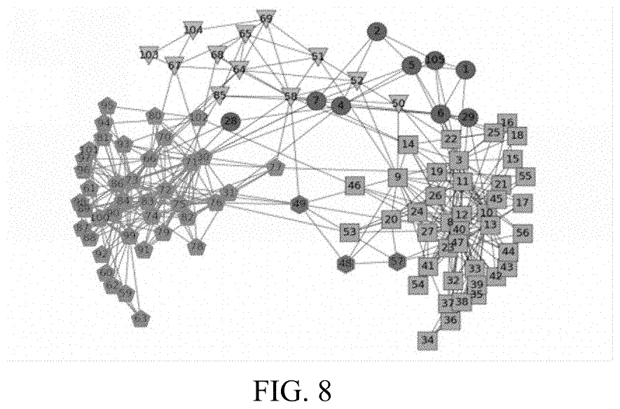

FIGS. 5-8 show the optimal community division result detected by CDEMO algorithm in 4 real world social networks. The experimental results show that in addition to the synthesized network, the CDEMO algorithm can also efficiently recognize the community structure of real social networks, which is more accurate and stable compared with a variety of cutting-edge effective modularity optimization algorithms. Therefore, this also further proves the effectiveness and the advancement of overall convergence performance of the algorithm.

7 tables involved in the present examples are described below:

TABLE 1
Details of Benchmark functions

| Function | Formulation | Range | Optimum |
|---|---|---|---|
| F1: Sphere | ${f}_{1} ( \vec{X} ) = {\sum }_{i = 1}^{D} {x}_{i}^{2}$ | −100 ≤ xᵢ ≤ 100 | f₁( [symbol] ) = 0 |
| F2: Schwefel | ${f}_{2} ( \vec{X} ) = {\sum }_{i = 1}^{D} {( {\sum }_{j = 1}^{i} {x}_{j} )}^{2}$ | −100 ≤ xᵢ ≤ 100 | f₂( [symbol] ) = 0 |
| F3: High conditioned Elliptic | ${f}_{3} ( \vec{X} ) = {\sum }_{i = 1}^{D} {( {10}^{6} )}^{\frac{i - 1}{D - 1}} {z}_{i}^{2}$ | −100 ≤ xᵢ ≤ 100 | f₃( [symbol] ) = 0 |
| F4: Schwefel with noise | ${f}_{4} ( \vec{X} ) = {\sum }_{i = 1}^{D} {( {\sum }_{j = 1}^{i} {x}_{j} )}^{2} * ( 1 + 0.4 \vert N ( 0 , 1 ) \vert )$ | −100 ≤ xᵢ ≤ 100 | f₄( [symbol] ) = 0 |
| F5: Noisy Quartic | ${f}_{5} ( \vec{X} ) = {\sum }_{i = 1}^{D} {ix}_{i}^{4} + rand [ 0 , 1 )$ | −1.28 ≤ xᵢ ≤ 1.28 | f₅( [symbol] ) = 0 |
| F6: Rosenbrock | ${f}_{6} ( \vec{X} ) = {\sum }_{i = 1}^{D} 100 {( {x}_{i}^{2} - {x}_{i + 1} )}^{2} + {( {x}_{i} - 1 )}^{2}$ | −100 ≤ xᵢ ≤ 100 | f₆( [symbol] ) = 0 |
| F7: Griewank | ${f}_{7} ( \vec{X} ) = {\sum }_{i = 1}^{D} \frac{{x}_{i}^{2}}{4000} - {\prod }_{i = 1}^{D} cos ( \frac{{x}_{i}}{\sqrt{i}} ) + 1$ | 0 ≤ xᵢ ≤ 600 | f₇( [symbol] ) = 0 |
| F8: Ackley | ${f}_{8} ( \vec{X} ) = - 20 exp ( - 0.2 \sqrt{\frac{1}{D} {\sum }_{i = 1}^{D} {x}_{i}^{2}} ) - exp ( \frac{1}{D} {\sum }_{i = 1}^{D} cos ( 2 π {x}_{i} ) ) + 20 + e$ | −32 ≤ xᵢ ≤ 32 | f₈( [symbol] ) = 0 |
| F9: Rastrigin | ${f}_{9} ( \vec{X} ) = {\sum }_{i = 1}^{D} ( {x}_{i}^{2} - 10 cos ( 2 π {x}_{i} ) + 10 )$ | −5.12 ≤ xᵢ ≤ 5.12 | f₉( [symbol] ) = 0 |
| F10: Rotated Rastrigin | ${f}_{10} ( \vec{X} ) = {\sum }_{i = 1}^{D} ( {z}_{i}^{2} - 10 cos ( 2 π {z}_{i} ) + 10 ) Z = X * M cond ( M ) = 2$ | −5.12 ≤ xᵢ ≤ 5.12 | f₁₀( [symbol] ) = 0 |
| F11: Noncontinuous Rastrigin | ${f}_{11} ( \vec{X} ) = {\sum }_{i = 1}^{D} ( {z}_{i}^{2} - 10 cos ( 2 π {z}_{i} ) + 10 ) {z}_{i} = \{ \begin{matrix}{x}_{i} & if \vert {x}_{i} \vert < 0.5 \\ round ( 2 {x}_{i} ) / 2 & else\end{matrix}$ | −5.12 ≤ xᵢ ≤ 5.12 | f₁₁( [symbol] ) = 0 |
| F12: Weierstrass | ${f}_{12} ( \vec{X} ) = {\sum }_{i = 1}^{D} {( {\sum }_{k = 0}^{k max} [ {a}^{k} cos ( 2 π {b}^{k} ( {x}_{i} + 0.5 ) ) ] )}^{2} - D {\sum }_{k = 0}^{ k max} [ {a}^{k} cos ( 2 π {b}^{k} \cdot 0.5 ) ]$ | −0.5 ≤ xᵢ ≤ 0.5 | f₁₂( [symbol] ) = 0 |
| | a = 0.5, b = 3, k max = 20 | | |
| F13: Generalized penalized function 1 | ${f}_{13} ( \vec{X} ) = \frac{π}{D} \{ \begin{matrix}10 {sin}^{2} ( π {y}_{1} ) + {\sum }_{i = 1}^{D - 1} {( {y}_{i} - 1 )}^{2} \times \\ [ 1 + 10 {sin}^{2} ( π {y}_{i + 1} ) ] + {( {y}_{D} - 1 )}^{2}\end{matrix} \} + {\sum }_{i = 1}^{D} u ( {x}_{i} , 10 , 100 , 4 )$ | −50 ≤ xᵢ ≤ 50 | f₁₃( [symbol] ) = 0 |
| | ${y}_{i} = 1 + \frac{1}{4} ( {x}_{i} + 1 )$ | | |
| F14: Generalized penalized function 2 | ${f}_{14} ( \vec{X} ) 0.1 \{ \begin{matrix} {sin}^{2} ( 3 π {y}_{1} ) + {\sum }_{i = 1}^{D - 1} {( {x}_{i} - 1 )}^{2} \times \\ [ 1 + {sin}^{2} ( 3 π {y}_{i + 1} ) ] + \\ ( {x}_{D} - 1 ) [ 1 + {sin}^{2} ( 2 π {x}_{D} ) ]\end{matrix} \} + {\sum }_{i = 1}^{D} u ( {x}_{i} , 5 , 100 , 4 )$ | −50 ≤ xᵢ ≤ 50 | f₁₄( [symbol] ) = 0 |
| F15: Expanded Griewank plus Rosenbrock | ${f}_{15} ( \vec{X} ) = {f}_{7} ( {f}_{6} ( {x}_{1} , {x}_{2} ) ) + {f}_{7} ( {f}_{6} ( {x}_{2} , {x}_{3} ) ) + . . . + {f}_{7} ( {f}_{6} ( {x}_{D} , {x}_{1} ) )$ | −3 ≤ xᵢ ≤ 1 | f₁₅( [symbol] ) = 0 |
| F16: Expanded Scaffer | $f ( {x}_{1} , {x}_{2} ) = 0.5 + \frac{{sin}^{2} \sqrt{{x}_{1}^{2} + {x}_{2}^{2}} - 0.5}{1 + 0.001 {( {x}_{1}^{2} + {x}_{2}^{2} )}^{2}}$ | −100 ≤ xᵢ ≤ 100 | ${f}_{16} ( {0}^{v} ) = 0$ |
| | ${f}_{15} ( \vec{X} ) = f ( {x}_{2} , {x}_{2} ) + f ( {x}_{3} , {x}_{4} ) + . . .$ | | |
| F17: Composition Function 1 (CF1) | The function (CF1) is composed by using ten sphere functions. C = 2000, σᵢ = 1, λᵢ = 5/100 | −5 ≤ xᵢ ≤ 5 | ${f}_{17} ( {0}^{v} ) = 0$ |
| F18: The Hybrid Composition Function | The Hybrid Composition function is composed by using ten different benchmark functions, i.e., two Rastrigin's functions, two Weierstrass functions, two | −5 ≤ xᵢ ≤ 5 | ${f}_{18} ( {0}^{V} ) = 0$ |
| | Griewank's functions, two Ackley's functions, and two Sphere functions. | | |
| | C = 2000 σᵢ = 1 | | |
| | σ = [1, 1, 10, 10, 5/60, 5/60, 5/32, 5/32, 5/100, 5/100 ] | | |

TABLE 2
Comparison of DE algorithms Convergence performance

| Functions | DE/rand/2/dir | DE/rand/1/bin | DE/rand-to-best/2/bin | DE/best1/bin | DE_version1 | DE_version2 |
|---|---|---|---|---|---|---|
| F₁: Sphere | 3.6994e−14 | 6.560e−37 | 4.543e−52 | 2.154e−105 | 6.654e−299 | 0.000e+00 |
| | (1.367e−13) | (2.116e−37) | (1.237e−51) | (1.080e−103) | (1.186e−296) | (0.000e+00) |
| f₂: Schwefel | 6.759e−01 | 2.069e−04 | 1.027e−04 | 6.225e+00 | 6.570e−52 | 0.000e+00 |
| | (1.97e−01) | (1.08e−04) | (3.26e−04) | (4.59e−01) | (5.161e−52) | (0.000e+00) |
| f₃: High conditioned | 3.257e−25 | 5.463e−58 | 1.667e−88 | 8.573e−102 | 1.680e−302 | 0.000e+00 |
| Elliptic | (2.116e−22) | (3.220e−57) | (2.100e−86) | (3.357e−101) | (4.074e−302) | (0.000e+00) |
| f₄: Schwefel | 4.442e−00 | 9.817e−06 | 9.886e−07 | 4.733e+02 | 2.705e−51 | 0.000e+00 |
| with noise | (3.61e−00) | (6.11e−05) | (2.29e−06) | (3.34e+01) | (2.640e−51) | (0.000e+00) |
| f₅: Noisy Quartic | 2.839e−02 | 8.128e−03 | 1.012e−03 | 3.937e−03 | 2.489e−05 | 5.123e−07 |
| | (3.57e−02) | (3.29e−03) | (1.29e−03) | (1.43e−02) | (1.475e−05) | (1.532e−07) |
| f₆: Rosenbrock | 5.750e−01 | 4.746e−01 | 5.198e−01 | 1.140e−15 | 2.579e+01 | 2.579e+01 |
| | (9.040e−00) | (3.570e−00) | (3.120e−00) | (3.767e−12) | (1.724e+00) | (1.724e+00) |
| f₇: Griewank | 8.460e−08 | 7.622e−32 | 8.860e−40 | 9.802e−38 | 0.000e+00 | 0.000e+00 |
| | (2.237e−07) | (2.267e−31) | (1.106e−40) | (1.960e−36) | (0.000e+00) | (0.000e+00) |
| f₈: Ackley | −1.829e−06 | −1.829e−06 | −1.829e−06 | −1.829e−06 | −1.829e−06 | −1.829e-06 |
| | (3.66e−06) | (2.20e−06) | (2.19e−06) | (1.44e−06) | (2.071e−06) | (1.260e−06) |
| f₉: Rastrigin | 7.219e+01 | 2.759e+01 | 9.714e+01 | 3.487e+01 | 5.684e−05 | 0.000e+00 |
| | (8.84e−00) | (6.14e−00) | (3.83e−00) | (5.77e−00) | (5.77e−00) | (0.000e+00) |
| f₁₀: Rotated Rastrigin | 4.895e+02 | 4.680e+01 | 5.700e+01 | 3.471e+01 | 1.980e+01 | 8.4649c−05 |
| | (3.66e−00) | (2.20e−00) | (4.17e−00) | (2.16e−00) | (1.087e−01) | (2.036e−04) |
| f₁₁: Noncontinuous | 9.835e+ 01 | 6.775e+02 | 1.285e+02 | 2.417e+02 | 1.105e+00 | 0.000e+00 |
| Rastrigin | (2.47e−01) | (3.11e−01) | (9.36e−01) | (4.23e−01) | (1.227e+00) | (0.000e+00) |
| f₁₂: Weierstrass | 3.763e+0l | 7.788e+00 | 2.767e+00 | 3.671e+00 | 0.000e+00 | 0.000e+00 |
| | (2.33e+00) | (2.10e+00) | (3.81e−00) | (3.66e+00) | (0.000e+00) | (0.000e+00) |
| f₁₃: Penalized 1 | 1.206e−24 | 1.570e−32 | 1.570e−32 | 1.570e-32 | 1.280e−02 | 1.280e−02 |
| | (2.30e−24) | (1.09e−32) | (3.11e−32) | (4.80e−32) | (3.216e−02) | (1.006e−02) |
| f₁₄: Penalized 2 | −1.1504+00 | −1.1504+00 | 1.1504+00 | −1.1504+00 | 3.430e−02 | 3.171e−02 |
| | (1.28e+00) | (1.12e+00) | (2.62e−00) | (3.20e+00) | (2.020e−02) | (1.324e−02) |
| f₁₅: Expanded Griewank | 8,770e+01 | 2.738e+01 | 3.336e+01 | 1.320e+01 | 9.442e+00 | 6.786e+00 |
| plus Rosenbrock | (3.96e−01) | (2.05e−01) | (7.20e−01) | (2.94e−01) | (1.392e−01) | (1.724e+00) |
| f₁₆: Expanded Scoffer | 7.776e+01 | 4.180e+01 | 2.560e+01 | 2.790e+01 | 8.453e−01 | 3.475e−01 |
| | (5.22e−01) | (5.51e−01) | (4.76e−01) | (3.27e−01) | (3.002e−01) | (1.2260e−01) |
| f₁₇: Composition | 6.483e−27 | 6.813e−66 | 5.668e−93 | 1.627e−106 | 0.000e+00 | 0.000e+00 |
| Function 1 (CF1) | (2.28e−27) | (3.10e−66) | (2.68e−93) | (2.35e−106) | (0.000e+00) | (0.000e+00) |
| f₁₈: Hybrid Composition | 9.806e−06 | 5.250e−06 | 4.617e−06 | 6.680e−06 | 9.980e−07 | 3.663e−07 |
| Function | (6.70e−06) | (2.22e−06) | (3.82e−06) | (4.51e−06) | (3.002e−07) | (2.852e−07) |

TABLE 3
Properties of Benchmark real world networks

| | Number of | Number of | Number of |
|---|---|---|---|
| Networks | nodes | edges | communities |
| Karate | 34 | 78 | [2, 10] |
| Dolphins | 62 | 159 | [2, 10] |
| Polbooks | 105 | 441 | [2, 10] |
| Football | 115 | 613 | [5, 15] |

| | Number of | Number of | Number of |
|---|---|---|---|
| Networks | nodes | edges | communities |
| Karate | 34 | 78 | [2, 10] |
| Dolphins | 62 | 159 | [2, 10] |
| Polbooks | 105 | 441 | [2, 10] |
| Football | 115 | 613 | [5, 15] |

TABLE 4
Comparison of DE algorithms in modularity optimization Performance

| Networks | DEMO1 | DEMO2 | DEMO3 | DEMO4 | DEMO5 | DEMO6 | CDEMO |
|---|---|---|---|---|---|---|---|
| Karate | 0.4176 | 0.4173 | 0.4150 | 0.4172 | 0.4172 | 0.4197 | 0.4198 |
| | (2.00e−03) | (2.31e−03) | (3.40e−03) | (1.92e−03) | (5.22e−03) | (3.10e−04) | (0.00e−00) |
| Dolphins | 0.5189 | 0.5166 | 0.4873 | 0.5136 | 0.5266 | 0.5277 | 0.5283 |
| | (3.70e−03) | (5.40e−03) | (3.80e−03) | (9.00e−03) | (1.74e−04) | (1.42e−04) | (3.11e−04) |
| Polbooks | 0.5262 | 0.5264 | 0.5236 | 0.5262 | 0.5266 | 0.5268 | 0.5270 |
| | (2.25e−04) | (2.14e−04) | (1.70e−03) | (1.00e−04) | (1.03e−04) | (1.45e−04) | (4.03e−04) |
| Football | 0.6046 | 0.6046 | 0.6043 | 0.6041 | 0.6045 | 0.6046 | 0.6046 |
| | (0.00e−00) | (0.00e−00) | (6.11e−04) | (7.04e−04) | (8.55e−05) | (0.00e−00) | (0.00e−00) |

TABLE 6
Optimal Q value for GATHB, MOGA-Net, ECGA,
and MOEA/D-Net on real world networks

| Networks | GATHB | MOGA | ECGA | MOEA/D |
|---|---|---|---|---|
| Karate | 0.4024 | 0.4160 | 0.4198 | 0.3715 |
| Dolphins | 0.5219 | 0.5050 | 0.5242 | 0.3735 |
| Polbooks | 0.5176 | 0.5180 | 0.5269 | 0.5180 |
| Football | 0.5508 | 0.5220 | 0.6010 | 0.6005 |

TABLE 7
Optimal values of Q for Meme-Net, MODPSO, DECD,
CCDECD, and IDDE on real world networks

| Networks | Meme-net | MODPSO | DECD | CCDECD | IDDE | CDEMO |
|---|---|---|---|---|---|---|
| Karate | 0.4198 | 0.4198 | 0.4198 | 0.4198 | 0.4198 | 0.4198 |
| Dolphins | 0.5191 | 0.5268 | 0.5249 | 0.5216 | 0.5282 | 0.5285 |
| Polbooks | 0.5255 | 0.5260 | 0.5262 | 0.5268 | 0.5271 | 0.5271 |
| Football | 0.6030 | 0.6032 | 0.6046 | 0.6046 | 0.6046 | 0.6046 |

The above are only the preferred embodiments of the present invention, but the scope of protection of the present invention is not limited thereto. Within the technical scope disclosed by the present invention, any equivalent substitution or variation that is made by persons skilled in the art according to the technical solution of the present invention and the inventive concept thereof should all be included within the scope of protection of the present invention.

What is claimed is:

1. A method for detecting a community structure of a complicated network, comprising: a step of improving the global convergence performance of the DE algorithm; a step of performing community correction based on improved neighborhood information; and a classification differential evolution algorithm-based modularity optimization method.

2. The method for detecting the community structure of the complicated network according to claim 1, characterized in that the step of improving the global convergence performance of the DE algorithm, comprising:
(1) a classification adaptive differential mutation strategy;
(2) a dynamic adaptive parameter adjustment;
(3) performing a differential selection operation based on historical information.

3. The method for detecting the community structure of the complicated network according to claim 2, characterized in that the classification adaptive difference classification mutation strategy is as follows:
for each target individual X_{i,t}, if a individual fitness value fᵢ thereof is greater than an average of individual fitness values of a current whole population, X_{i,j} is classified as a superior individual, and its position in a search space is closer to a global optimal solution; therefore, a good gene in X_{i,t} is reserved to enhance a local search around the individual, and a corresponding mutation vector V_{i,t} is generated as follows:
V_{i,t}=F_{i,t}·X_{pbesti,t}+W_{i,t}·(X_{r2,t}−X_{r3,t}) (1)
where X_{pbesti,t} indicates a historical optimal solution of the individual X_{i,t} in the previous t generations and is used for improving exploration capability of the individual; X_{r2,t} and X_{r3,t} are two different individuals randomly selected from the population and satisfy a condition: r2≠r3#i; F_{i,t} and W_{i,t} are control parameters of Xᵢ, and their values are dynamically adjusted according to an evolutional algebra and the individual fitness value of X_{i,t};
for each target individual X_{i,t}, if a individual fitness value fᵢ thereof is less than an average of the individual fitness values of the whole population, X_{i,t} is classified as a poor individual, and a position thereof in the search space is far from a global optimal solution; therefore, the communication between the poor individual and the superior individual should be enhanced to promote a global search, a corresponding mutation vector V_{i,t} is generated as follows:
V_{i,t}=W_{i,t}·X_{r1,t}+K_{i,t}·(X_{gbest,t}−X_{i,t}) (2)
where X_{r1,t} is an individual randomly selected from the population and satisfies the condition: r1≠i; X_{gbest,t} indicates a optimal solution in the current iterative population, and is used for improving exploration capability of X_{i,t}; W_{i,t} and K_{i,t} are control parameters of Xᵢ, and values thereof are dynamically adjusted according to an evolutional algebra and the individual fitness value of X_{i,t}.

4. A method for detecting the community structure of the complicated network according to claim 2, characterized in that the dynamic adaptive parameter adjustment, three control parameters W, K, and F is respectively a random component, a social component, and a cognitive component in the mutation process, in addition, a crossover operation further comprises a key control parameter CR for determining a percentage of each test individual μ_{i,t} inherited from a mutant individual V_{i,t}; the adjustment process is as follows:
$$\begin{matrix}{W}_{i , t} = {W}_{min} + ( {W}_{max} - {W}_{min} ) \times ( ( 2 - exp ( \frac{t}{{t}_{max}} \times ln 2 ) ) \times \frac{1}{2} + \frac{{f}_{max , t} - {f}_{i , t}}{{f}_{max , t} - {f}_{min , t}} \times \frac{1}{2} ) & ( 3 ) \\ {K}_{i , t} = {K}_{min} + ( {K}_{max} - {K}_{min} ) \times ( ( exp ( \frac{t}{{t}_{max}} \times ln 2 ) - 1 ) \times \frac{1}{2} + \frac{{f}_{max , t} - {f}_{i , t}}{{f}_{max , t} - {f}_{min , t}} \times \frac{1}{2} ) & ( 4 ) \\ {F}_{i , t} = {F}_{min} + ( {F}_{max} - {F}_{min} ) \times ( ( 2 - exp ( \frac{t}{{t}_{max}} \times ln 2 ) ) \times \frac{1}{2} + \frac{{f}_{i , t} - {f}_{min , i}}{{f}_{max , t} - {f}_{min , t}} \times \frac{1}{2} ) & ( 5 ) \\ {CR}_{i , t} = {CR}_{min} + ( {CR}_{max} - {CR}_{min} ) \times ( ( 2 - exp ( \frac{t}{{t}_{max}} \times ln 2 ) ) \times \frac{1}{2} + \frac{{f}_{max , t} - {f}_{i , t}}{{f}_{max , t} - {f}_{min , t}} \times \frac{1}{2} ) . & ( 6 )\end{matrix}$$

5. The method for detecting the community structure of the complicated network according to claim 2, characterized in that, the differential selection operation based on historical information is as follows:
a historical optimal solution X_{pbesti,t} of each individual in a population constitutes pbest_pop of the population, is generated at the initialization stage, and updated after each evolution operation; for each individual X_{i,t} in the population, if a fitness value thereof is improved during a certain evolution operation process, a newly generated individual is used as the current historical optimal solution of X_{i,t}, and saved to pbest_pop; after each generation of evolution operations, all individuals in pbest_pop will replace all individuals in a population pop, and the current optimal solution X_{gbest,t} is selected from pbest_pop.

6. The method for detecting the community structure of the complicated network according to claim 1, characterized in that, the step of performing community correction based on improved neighborhood information is as follows: if a node satisfies a community correction condition, the node will be replaced into a community to which all neighborhood nodes belong, and a probability of replacement is proportional to a scale of a neighborhood community.

7. A method for detecting the community structure of the complicated network according to claim 1, characterized in that, the modularity optimization method based on the classification differential evolution algorithm is as follows:
S1: initializing a population;
S1.1 setting network parameters, including a number of nodes n, an adjacent matrix adj, and a community correction threshold δ; setting parameters of a DE algorithm, including an individual dimension D, a population size NP, a number of population iterations t, and a maximum iteration tₘₐₓ;
S1.2 randomly initializing the population pop by the community-labeled individual representation approach;
S2: recognizing and recording an optimal solution;
S2.1 recognizing and recording an optimal individual X_{gbest,t} in the population pop of t-th generation;
S2.2 recognizing and recording a historically optimal solution X_{pbesti,t} of each individual X_{i,t} in the population pop of the t-th generation; and establishing an initial population pbest_pop from X_{pbesti,t} of all population individuals;
S3: when a number of population iterations is less than the maximum population iteration, automatically adding one to the number of population iterations; and a cycle of S3.1-S3.5 is terminated if the conditions are not satisfied;
S3.1 establishing a mutation population mutation pop by the adaptive classification differential mutation strategy;
when a value of i is within a range from 1 to a value of the population size, carrying out a cycle of steps a) to e); if a value of i is not within the range from 1 to the value of the population size, skipping steps a) to e) and terminating the cycle;
a) randomly selecting 3 different individuals X_{r1,t}, X_{r2,t}, and X_{r3,t} from the population pop;
b) dynamically adjusting mutation parameters F_{i,t}, w_{i,t}, and K_{i,t};
c) classifying X_{i,t} according to a fitness value Q;
d) generating a mutation individual V_{i,t}, according to the adaptive classification differential mutation strategy;
e) calculating a modularity value of V_{i,t}, comparing it with the individual X_{i,t} and saving a better individual into pbest_pop;
if i is greater than NP, skipping the steps a) to e);
S3.2 performing the community correction based on the neighborhood information;
S3.3 constructing a crossover population crossover_pop, according to the mutation population mutation_pop and the population pop;
when a value of i is in a range from 1 to a value of the population size, carrying out steps a) to d); if a value of i does is not in a range from 1 to the value of the population size, skipping the steps a) to d), and terminating the cycle;
a) initializing an i-th individual u_{i,t}=x_{i,t} in the crossover population;
b) dynamically adjusting a crossover parameter CR_{i,t};
c) adjusting a test individual u_{i,t} by inheriting community information from a mutation individual V_{i,t};
d) calculating a modularity value of u_{i,t}, and comparing it with an i-th individual in pbest_pop, and saving a better value into pbest_pop;
S3.4 performing the community correction based on the neighborhood information;
S3.5 updating pop by replacing all individuals in pbest_pop;
S4: outputting X_{gbest,t} in pop as a final optimal community division; otherwise, returning to step S3.
